(19) United States
(12) Patent Application Publication
(10) Pub. No.: US 2018/0216717 A1
(43) Pub. Date: Aug. 2, 2018

(54) ELECTROMOTIVE ANCILLARY UNIT

(71) Applicant: Brose Fahrzeugteile GmbH & Co. Kommanditgesellschaft, Coburg, Coburg (DE)

(72) Inventor: Vineet Jason THOTAKURI, Rochester Hills, MI (US)

(73) Assignee: Brose Fahrzeugteile GmbH & Co. Kommanditgesellschaft, Coburg, Coburg (DE)

(21) Appl. No.: 15/420,602

(22) Filed: Jan. 31, 2017

(51) Int. Cl. F16H 57/00; F16H 1/16; F16H 57/021; F16H 57/031; B60N 2/02

(52) U.S. Cl. CPC F16H 57/0006; F16H 1/16; F16H 2057/02034; F16H 57/031; B60N 2/0232; F16H 57/021

(57) ABSTRACT

An electromotive ancillary unit of a motor vehicle, particularly a seat adjustment, having a mounting plate and an adjustment drive having an electric motor and a gearing mechanism. The gearing mechanism is disposed within a gearbox closed by means of a cover through which an output shaft connected to the gearing mechanism protrudes. The gearbox is mounted on the mounting plate, and the cover abuts to the mounting plate via a damping element in the axial direction of the output shaft. The invention further relates to a seat of a motor vehicle having a seat adjustment.

### BACKGROUND OF THE INVENTION

### Field of the Invention

The invention relates to an electromotive ancillary unit of a motor vehicle comprising a mounting plate and an adjustment drive. The electromotive ancillary unit can include a seat adjustment. The invention further relates to a seat of a motor vehicle comprising a seat adjustment.

### Description of the Background Art

Motor vehicles have a variety of (electromotive) ancillary units which do not directly serve the propulsion of the motor vehicle. In most cases, the comfort of the user of the motor vehicle is enhanced by means of these ancillary units. Such ancillary units are, for example, electromotive window lifters or electromotively operated luggage compartment lids. Here, an adjustment element, namely a window or a luggage compartment lid, is driven by means of an electric motor so that the adjustment element doesn't have to be operated manually. Other such ancillary units are, for example, an electromotive seat adjustment in which the constituent parts of a seat such as a backrest or the entire seat are moved by means of an electric motor. Even electromotively adjustable head rests are known.

During the operation of the electric motor there will be an excitation of a potential housing of the ancillary unit or other constituent parts of the motor vehicle connected to the ancillary unit. In other words, mechanical vibrations of the ancillary unit or the connected constituent part are induced. Consequently, noise will develop which impairs comfort of the user. There may also be a tactile perception of the vibrations. To avoid such excitation, the electric motor is usually balanced. Therefore, manufacturing is prolonged due to an additional work step which will increase the manufacturing costs.

### SUMMARY OF THE INVENTION

It is therefore an object of the invention to provide both a particularly suitable ancillary unit for a motor vehicle and a particularly suitable seat of a motor vehicle, wherein particularly the comfort of a user is enhanced and preferably the manufacturing costs and/or a production time are reduced.

In an exemplary embodiment, the ancillary unit is a constituent part of a motor vehicle and comprises an adjustment drive comprising an electric motor and a gearing mechanism. During operation, an adjustment element is moved along an adjustment path by means of the adjustment drive. For example, the adjustment drive can be an (electromotive) window lifter, an electromotively operated luggage compartment lid, or an electromotively operated door such as a sliding door. Alternatively, the adjustment drive can be an electromotive sun roof or an electromotively operated folding top. In an embodiment the ancillary unit can be a pump such as, for example, a lubricant pump. In particular, the ancillary unit can be an oil pump, for example, a motor oil or gearbox oil pump. In an alternative, the pump can be a coolant pump or an air-conditioning compressor. Usefully, the ancillary unit can be an electromotive steering support or an ABS or ESP unit. In a further alternative, the ancillary unit can be an electromotive parking break or another electric brake. For example, the ancillary unit can be a massage facility of a seat. In other words, a massage function can be performed during the operation of the ancillary unit. In the process, for example, a constituent part of the seat such as the seating area or a backrest is moved, particularly periodically.

The ancillary unit can be a constituent part of a seat and serves, for example, to adjust the seat or a part of the seat such as a backrest or head rest. In other words, the ancillary unit can be a seat adjustment. Here, for example, a change of an inclination of the backrest or the seating area is induced by means of the seat adjustment. Alternatively, a position of the backrest, the head rest, or the seating area is adjusted in one plane by means of the seat adjustment.

The gearing mechanism can be driven by means of the electric motor. In particular, a gear wheel is connected to a motor shaft of the electric motor, for example, superimposed to it. The gearing mechanism is disposed within a gearbox. Here, for example, potential gear wheels or other mechanical constituent parts of the gearing mechanism serving the transmission of a torque are located inside the gearbox. The gearbox is closed by means of a cover. In particular, the cover covers an opening/recess of the gearbox, wherein the gearing mechanism can be mounted through the opening/recess. Preferably, the gearing mechanism is substantially fully surrounded by the gearbox and the cover so that damage to the gearing mechanism is avoided by means of the gearbox and the cover, and, for example, the cover is fitted into a recess of the gearbox. For example, the cover can be fixed to the gearbox by a fastenor such as a screw or a clip or the like.

An output shaft of the adjustment drive connected to the gearing mechanism protrudes through the cover. In particular, the output shaft can be driven by means of the gearing mechanism, or the output shaft is integrally formed with constituent parts of the gearing mechanism and thus formed in one piece, i.e. monolithic with the same. The output shaft itself can be connected to other components of the ancillary unit which are, in consequence, driven by the output shaft. The output shaft is preferably mounted so as to be rotatable about a rotational axis, for example, by means of a plain bearing. The plain bearing can be connected to the cover. For example, the cover comprises an opening through which the output shaft protrudes. The bearing is usefully disposed in the area of the opening.

The gearbox is fixed to a mounting plate. Ideally, the gearbox is detachably mounted to the mounting plate, particularly by means of screws. In this way, repair is facilitated. Alternatively, the gearbox is, for example, caulked or snap-fit with the mounting plate. In particular, the mounting plate is located on the side of the cover which is usefully disposed in the axial direction of the output shaft between the mounting plate and the gearbox. The axial direction of the output shaft particularly designates a direction which is parallel to a symmetry axis of the output shaft if it has one. Ideally, the axial direction is parallel to an axis about which the output shaft is rotating during operation. In particular, the cover is covered by the mounting plate. Preferably, the mounting plate also comprises a recess through which the output shaft protrudes. If the electromotive ancillary unit is a seat adjustment the mounting plate is usefully a lateral seat plate part.

The mounting plate serves the fixation of the adjustment drive to other components of the ancillary unit or to other components of the motor vehicle. The mounting plate can be adapted to the desired field of application. In the axial direction, a damping element is disposed between the cover and the mounting plate so that the cover abuts to the mounting plate via the damping element. Preferably, the damping element mechanically directly abuts to the mounting plate here. Alternatively, or particularly preferable in combination here, the damping element mechanically can directly abut to the cover. Vibrations of the adjustment drive regarding the mounting plate are attenuated by means of the damping element. In particular, a vibration of the cover regarding the mounting plate is attenuated by means of the damping element and thereby reduced. Consequently, the propagation of vibrations to the mounting plate is reduced so that, on the one hand, noise development and, on the other hand, propagation of mechanical vibrations to other constituent parts of the motor vehicle are prevented. Therefore, the comfort of a user is enhanced, and the electric motor as well as other constituent parts of the gearing mechanism do not have to be balanced to a comparatively fine degree. Rather, the vibrations are absorbed by the damping element so that a production time can be reduced whereby the manufacturing costs are reduced.

For example, the damping element is offset in a preferred direction with respect to the output shaft. Ideally, the damping element surrounds the output shaft circumferentially so that the cover abuts to the mounting plate in a comparatively large area. Here as well vibrations of the cover relative to the mounting plate are substantially attenuated in all directions with regard to the rotational axis so that even in case of a potential imbalance of the output shaft and a resulting tumbling motion of the cover relative to the mounting plate a direct mechanical contact to the mounting plate is avoided.

For example, the cover is provided with a collar circumferentially surrounding the output shaft. The collar is ideally directed away from the gearbox. The collar can extend in the axial direction of the output shaft. In other words, the collar is, at least partly, formed by a hollow cylinder the axis of which is parallel to the axial direction. The collar can be disposed concentrically with regard to output shaft so that the axis of the hollow cylinder coincides with the rotational axis of the output shaft. For example, the output shaft abuts to the cover in the area of the collar. In other words, the output shaft abuts to the collar, for example, mechanically and directly. In other words, a plain bearing for the output shaft is provided by the collar. Put differently, the collar is formed as a bearing position for the output shaft.

Alternatively, the output shaft abuts to the collar via another element, for example, a bearing element. Here, the collar can serve to accommodate the bearing element. The bearing element can be, for example, a plain bearing. Here, a friction coefficient of the bearing element is smaller than that of the collar. Therefore, the output shaft is stabilised by means of the collar. The collar can be disposed between the damping element and the output shaft, ideally in a radial direction of the output shaft. The damping element preferably abuts to the outside of the collar. Here the damping element is stabilised by means of the collar, and the position of the damping element is determined by the collar. In this way, mounting is facilitated, and a separation of the damping element from the adjustment drive is substantially prevented.

Preferably the mounting plate circumferentially surrounds the collar. Therefore, the mounting plate is disposed radially with regard to the output shaft in the area of the collar. In this way, a comparatively compact electromotive ancillary unit is provided. The mounting plate circumferentially abuts to the collar. In this way, the collar, and particularly also the output shaft, are stabilised by the mounting plate, provided it is stabilised by the collar. Consequently, substantially only a vibration in an axial direction is attenuated by means of the damping element, the collar being guided by the mounting plate in the axial direction. Therefore, no imbalance is induced in the adjustment drive owing to the damping element, and the position of the output shaft in the radial direction is determined by the collar and the mounting plate.

For example, the damping element has the form of a hollow cylinder or disk. It is particularly preferable that the damping element is a washer. In other words, a washer can be used as the damping element. Ideally, the damping element circumferentially surrounds the output shaft and usefully circumferentially abuts to the collar of the cover. The disk-shaped washer having the form of a hollow cylinder can be manufactured at comparatively low costs. Mounting is also facilitated by inserting the collar into it. Consequently, the manufacturing costs are reduced.

It is particularly preferable that the damping element is made of an elastic material. In particular, rubber can be used as the elastic material. Therefore, the damping properties of the damping element are improved while the manufacturing costs are reduced. Alternatively, or particularly preferable in combination with that, the mounting plate is made of metal. In this way, the gearbox is kept comparatively stable by means of the metal plate, and the robustness of the electromotive ancillary unit is increased. In addition, the cover is protected from potential damage by means of the mounting plate. The damping element can be formed of rubber, and the mounting plate can be made of metal. Alternatively, either the damping element is formed of rubber, or the mounting plate is made of metal. For example, the metal is aluminium or steel.

The cover is, in particular, formed of a plastic material, for example by a plastic injection moulding method. Therefore, manufacturing costs are reduced. Here, the mounting plate is preferably formed of the metal, and the cover is covered by the mounting plate. Therefore, the gearing mechanism is protected from damage by both the cover and the mounting plate. Alternatively or in combination with that, the gearbox is formed of a plastic material, particularly by an injection moulding method. Summarising, the cover and the gearbox are, in one example, made of a plastic material, wherein, usefully, the same plastic material is used for both the cover and the gearbox. In the alternative, either the cover or the gearbox is made of the plastic material.

For example, the gearing mechanism is provided with a worm drive. In particular, the worm drive is designed so as to be self-inhibiting. Therefore, a reverse rotation of the gearing mechanism in case of a torque applied to the output shaft by the component to be driven is prevented by means of the worm drive. Particularly if the electromotive ancillary unit is a seat adjustment, therefore, a reverse rotation of the electric motor and thus an unintended readjustment of the seat is avoided in case of a load being applied to the seat by the user.

For example, the gearing mechanism comprises a tumble gearing. The tumble gearing is, for example, an epicyclic gear comprising an excentrically moved element, preferably a gear wheel which is usefully set into an orbiting motion during operation, wherein the gear wheel itself is rotated. Alternatively, the gear wheel is only moved transversally, i.e. only orbiting. Usefully, this gear wheel rolls on an internal gearing of another gear wheel. The tumble gearing provides for a comparatively high gear reduction so that a comparatively high speed of the electric motor only results in a comparatively low speed of the output shaft. Consequently, even an electric motor having comparatively small size and providing a comparatively small torque but a comparatively high speed can be used to generate a comparatively large torque by means of the output shaft. Summarising, the gearing mechanism according to one embodiment comprises the worm drive and the drum drive. In another embodiment the gearing mechanism comprises either the worm drive or the tumble gearing.

The output shaft can be provided with a pinion. Another component of the electromotive ancillary unit or another component of the motor vehicle is driven by means of the pinion. The pinion itself is preferably integrally formed with the output shaft, i.e. formed in one piece with it. In other words, the output shaft and the pinion have a monolithic configuration. The pinion itself usefully has an integral, i.e. monolithic configuration and is, for example, a pinion formed by cold extrusion.

The electric motor is, for example, an asynchronous motor. Preferably, however, the electric motor is a synchronous motor. The electric motor is, for example, a brushless direct current motor (BLDC). It is particularly preferable that the electric motor is a commutator motor provided with brushes. The electric motor therefore preferably comprises at least two brushes as well as a commutator which usefully comprises a number of fins. The electric motor can be manufactured at comparatively low costs. Particularly if the electromotive ancillary unit is a seat adjustment the number of adjustment movements is comparatively low. Consequently, wear of the brushes is also low so that a period of use is still comparatively high. Such an electric motor can, however, be produced at comparatively low costs so that the manufacturing costs of the electromotive ancillary unit are reduced. Summarising, the output shaft is provided with the pinion, and the electric motor is a commutator motor provided with brushes. In two further alternatives, the output shaft is provided with the pinion, or the electric motor is a commutator motor provided with brushes.

The seat is a constituent part of a motor vehicle and, for example, a driver's or front passenger's seat. The seat particularly comprises a seating area and a backrest. Further, the seat is provided with a seat adjustment comprising a mounting plate and an adjustment drive. The adjustment drive comprises an electric motor and a gearing mechanism disposed inside of a gearbox. The gearbox is closed by means of a cover through which an output shaft connected to the gearing mechanism protrudes. The gearbox is mounted on the mounting plate, and the cover abuts to the mounting plate via a damping element in an axial direction of the output shaft. During operation, for example, a change of the inclination of the backrest relative to the seating area is effected by means of the seat adjustment. It is particularly preferable that the seat adjustment is used to move the seating area while particularly the backrest is also moved. Ideally, a change of height of the seating area is effected by means of the seat adjustment. Alternatively or in combination with this, a shift of the seating area, substantially in a horizontal plane, is effected by means of the seat adjustment. The mounting plate is, in these cases, preferably a lateral seat plate part.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematically facilitated view of a seat of a motor vehicle comprising a seat adjustment,

FIG. 2, 3 shows respective perspective views of an adjustment drive of the seat adjustment,

FIG. 4 shows an exploded view of the seat adjustment,

FIG. 5 shows a perspective view of a section of the adjustment drive, and

FIG. 6, 7 shows a respective sectional view of the seat adjustment.

### DETAILED DESCRIPTION

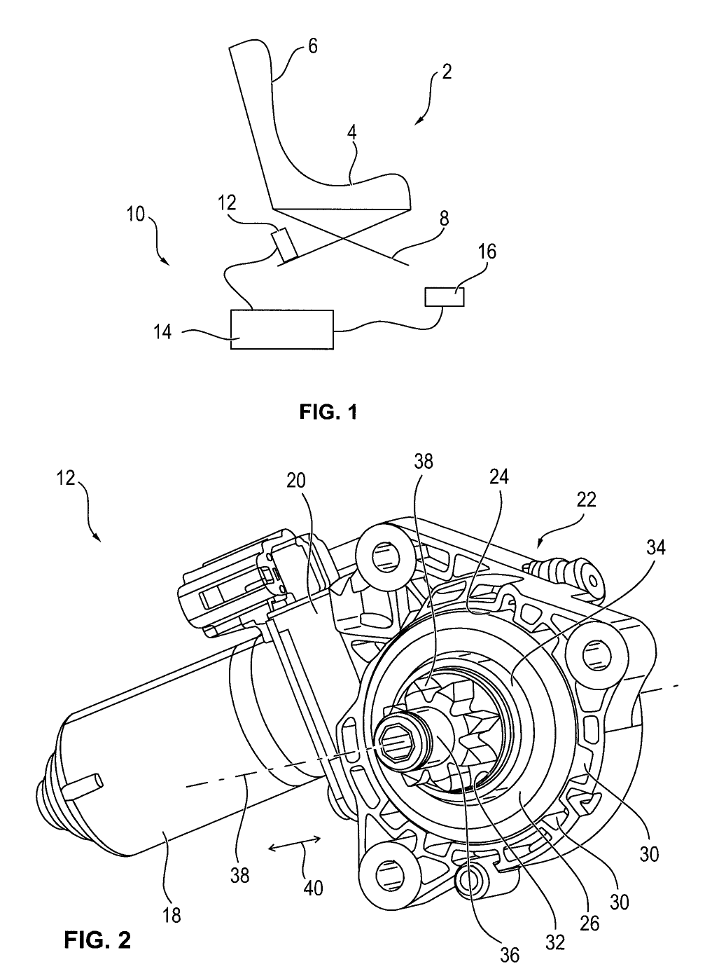

FIG. 1 shows a schematically facilitated view of a seat 2 of a motor vehicle comprising a seating area 4 and a backrest 6. Below the seating area 4, the mechanics 8 of an electromotive ancillary unit 10 in the form a seat adjustment are disposed. A position of the seating area 4 and the backrest 6 connected thereto is changed by means of the mechanics 8, both being either lifted or lowered. In other words, a height adjustment is concerned. The electromotive ancillary unit 10 comprises an adjustment drive 12 connected to a control unit 14 in terms of signalling or electrically. The control unit 14 itself is connected to a sensing device 16 in terms of signalling. During operation, the sensing device 16 is activated by a user. This is detected by means of the control unit 14, and depending thereon, the adjustment drive 12 is operated to which end an electric current flow towards it is established. The mechanics 8 are driven by means of the adjustment drive 12. Consequently, the height of the seating area 4 and the backrest 6 connected to it are changed.

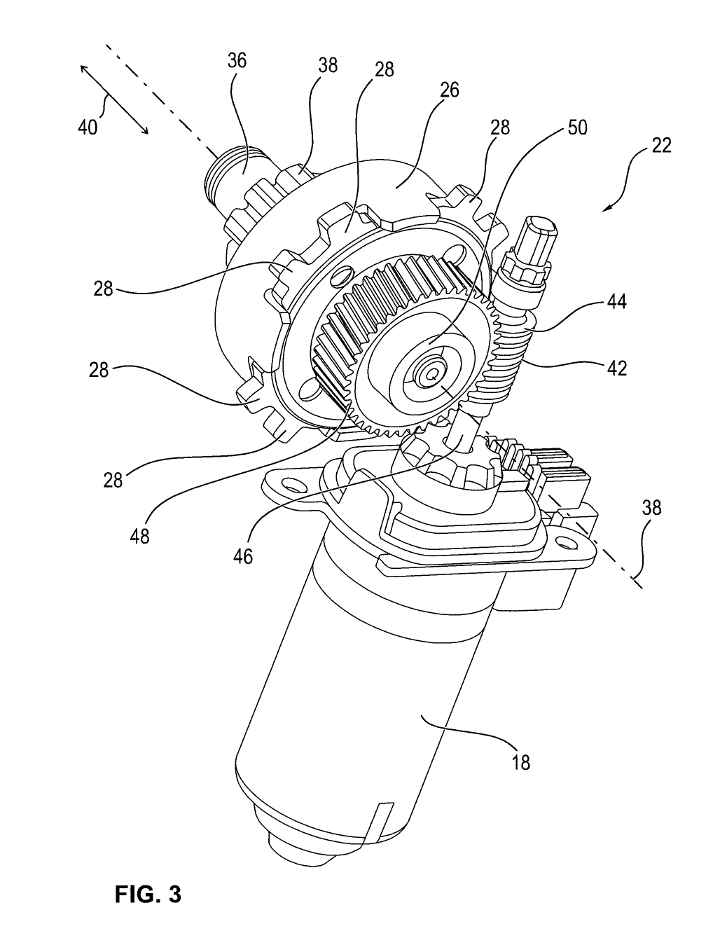

In FIG. 2 a perspective view of the adjustment drive 12 is shown. It comprises an electric motor 18 which is a commutator motor provided with brushes. On the face side, the electric motor is mounted on a gearbox 20 of a gearing mechanism 22 manufactured from a plastic material by means of an injection moulding method. The gearbox 20 comprises a recess 24 closed by a cover 26. The cover 26 is formed of the same plastic material as the gearbox 20 and also produced by means of a plastic injection moulding process.

As shown in FIG. 3, the pot-shaped cover 26 comprises studs 28 protruding to the outside and located in associated grooves 30 of the gearbox 20. A anti-twist protection of the cover 26 relative to the gearbox 20 is realised by means of the studs 28 and the grooves 30. The cover 26 has a central opening 32 formed by a collar 34 having a hollow cylindrical design. The collar 34 is disposed at the bottom of the pot-shaped cover 26 and is directed away from the gearbox 20. An output shaft 36 provided with a pinion 38 protrudes through the opening 32 and therefore through the collar 34. The pinion 38 is integrally and therefore monolithically formed with the output shaft 36. The output shaft 36 is supported so as to be rotatable about a rotational axis 38 which is parallel to an axial direction 40. The collar 34 is rotationally symmetric with regard to the rotational axis 38 here, and therefore also extends in axial direction 40. The output shaft 36 protrudes through the collar 34 which therefore circumferentially surrounds the output shaft 36.

As shown in FIG. 3 with the gearbox 20 removed, the gearing mechanism 22 is provided with a worm drive 42 the worm gear 44 being superimposed to a motor shaft 46 of the electric motor 18. This constituent part of the motor shaft 46 is disposed within the gearbox 20 in the mounted state. A worm wheel 48 of the worm drive is disposed on an intermediate shaft 50 and drives it.

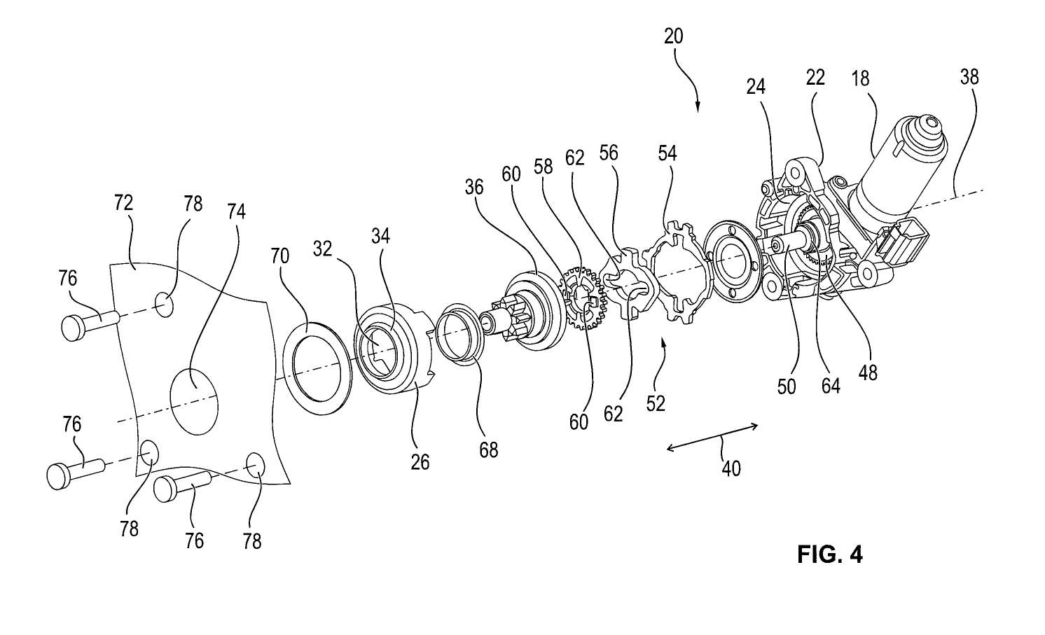

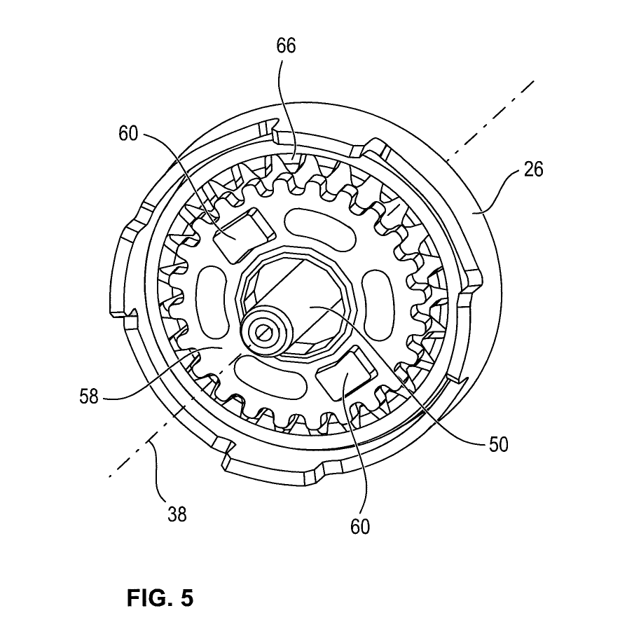

In FIG. 4, the electromotive ancillary unit 10 is partially shown in an exploded view. The gearing mechanism 20 further comprises a tumble gearing 52 which comprises a ring-shaped guide disk 54 and a crossbar 56. By means of these, a tumbling wheel 58 is guided in a plane which is perpendicular to the axial direction 40, an intrinsic rotation of the tumbling wheel 58 relative to the crossbar 56 being prevented by detents 60 of the tumbling wheel 58 which engage in associated retainers 62 of the crossbar 56. The tumbling wheel 58 is moved within the plane by means of an eccentric tappet 64 disposed on the intermediate shaft 50. In the course of these movements the tumbling wheel 58 provided with exterior teeth engages in an internal gearing 66 of the output shaft 36 and rolls along in it as shown in FIG. 5. Consequently, the output shaft 36 is set into a rotary motion about the rotational axis 38.

On the output shaft 36, a bearing element 68 in the form of a plain bearing ring is mounted which is circumferentially surrounded by the collar 34 of the cover 26. The output shaft 36 is stabilised within the opening 32 of the cover 26 by means of the bearing element 68. In addition, friction of the output shaft 36 during a rotary motion about the rotational axis 38 is reduced by means of the bearing element 68.

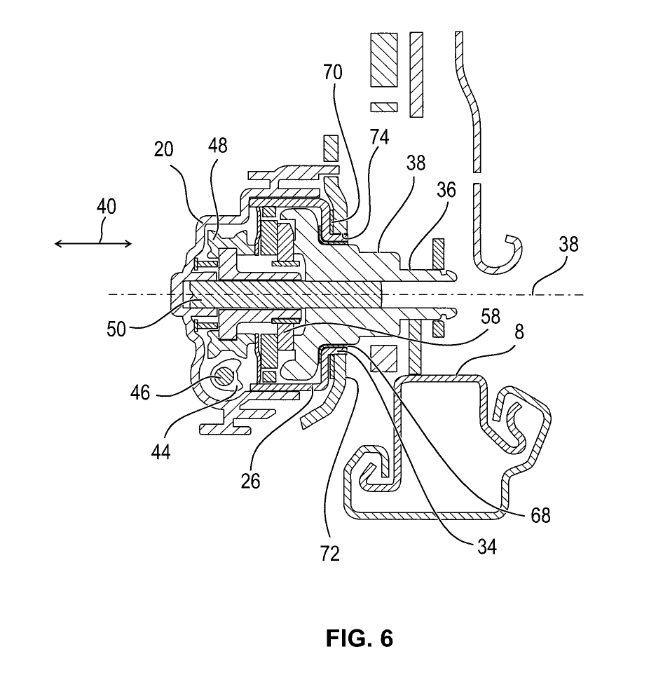

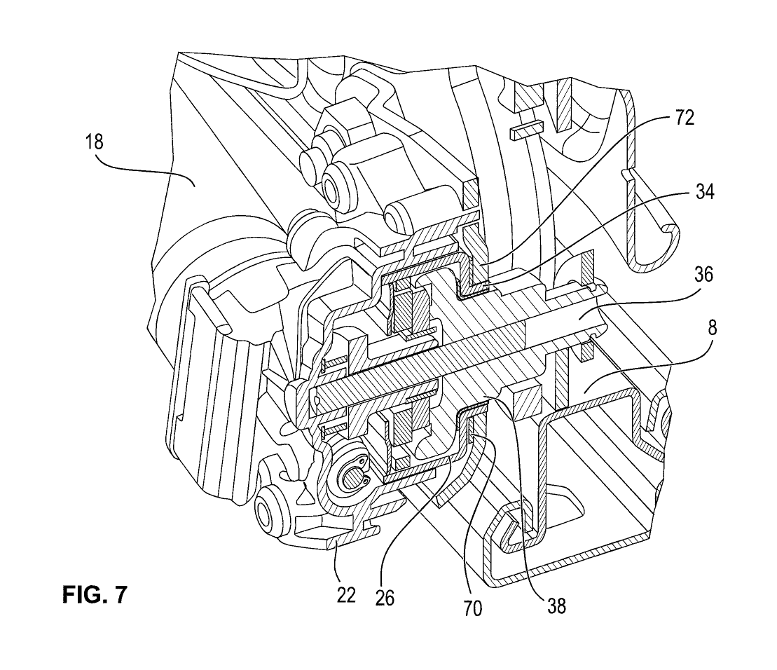

The electromotive ancillary unit 10 further comprises a damping element 70 in the form of a washer disposed perpendicular to the axial direction 40. The damping element 70 is made of an elastic rubber and circumferentially abuts to the collar 34. Consequently, the damping element 70 circumferentially surrounds the output shaft 36. In other words, the collar 34 is disposed between the damping element 70 and the output shaft 36. Further, the electromotive ancillary unit 70 comprises a mounting plate 72 in the form of a lateral seat plate part. The mounting plate 70 is manufactured of metal which is, for example, powder-coated. The mounting plate 72 has an opening 74 in which the free end of the collar 34 is disposed as shown in FIG. 6 in a lateral sectional view and in FIG. 7 in a perspective sectional view. Therefore, the mounting plate 72 which has a substantially planar design and extends perpendicular to the axial direction 40 circumferentially surrounds the collar 34 and abuts to it forming a clearance fit. Therefore, the output shaft 36 is disposed between the cover 26 and the mounting plate 72 of the damping element 70 in the axial direction 40, the cover 26 abutting to the mounting plate 72 via the damping element 70 in the axial direction 40.

The mounting plate 72 is mounted on the gearbox 22 by means of three screws 76 guided through an associated screw opening 78 in the mounting plate 72. Therefore, is the cover 26 abuts to the mounting plate 72 via a damping element 70 in the axial direction 40 of the output shaft 36. Vibrations of the cover 26 relative to the mounting plate 72 are attenuated by means of the damping element 70 so that they will not be transmitted to the mounting plate 72. Consequently, no excitation of the mounting plate 72 will take place which will be transmitted to the cover 26 due to the engagement of the teeth of the gearing mechanism 20. Thereby, the acoustic impression during the operation of the seat adjustment 10 is improved.

The invention is not limited to the embodiment described above. Rather, other variants of the invention can be derived by persons skilled in the art without deviating from the subject matter of the invention. In particular, all individual features described in connection with the embodiment can be further combined in other ways without deviating from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. An electromotive ancillary unit of a motor vehicle, particularly a seat adjustment, the electromotive ancillary unit comprising:
a mounting plate; and
an adjustment drive comprising an electric motor and a gearing mechanism disposed inside of a gearbox and closed via a cover through which an output shaft connected to the gearing mechanism protrudes,
wherein the gearbox is mounted to the mounting plate,
wherein the cover abuts to the mounting plate via a damping element in an axial direction of the output shaft,
wherein the cover comprises a collar that circumferentially surrounds the output shaft and a first portion of the collar is disposed between the damping element and the output shaft in a direction perpendicular to the axial direction, and
wherein the mounting plate circumferentially surrounds the collar and directly abuts to a second portion of the collar.

2. The electromotive ancillary unit according to claim 1, wherein the damping element circumferentially surrounds the output shaft.

3. (canceled)

4. (canceled)

5. The electromotive ancillary unit according to claim 1, wherein the damping element is a washer.

6. The electromotive ancillary unit according to claim 1, wherein the damping element is made of rubber and/or the mounting plate is made of a metal.

7. The electromotive ancillary unit according to claim 1, wherein the cover and/or the gearbox are formed of a plastic material.

8. The electromotive ancillary unit according to claim 1, wherein the gearing mechanism comprises a worm drive and/or tumble gearing.

9. The electromotive ancillary unit according to claim 1, wherein the output shaft is provided with a pinion that is integrally formed, and/or wherein the electric motor is a commutator motor provided with brushes.

10. A seat of a motor vehicle comprising electromotive ancillary unit according to claim 1, wherein the electromotive ancillary unit is a seat adjustment.

11. The electromotive ancillary unit according to claim 1, further comprising a bearing element that is non-integrally mounted on the output shaft, the bearing element having a circumferential collar, wherein an outer surface of the collar of the bearing element abuts an internal surface of the collar of the cover and wherein a coefficient of friction the bearing element is smaller than a coefficient of friction of the collar of the cover.
